(19) United States
(12) Patent Application Publication
(10) Pub. No.: US 2017/0274444 A1
(43) Pub. Date: Sep. 28, 2017

(54) METHOD OF MANUFACTURING BIFURCATED PIPE AND BIFURCATED CONNECTOR FOR CONNECTING HOSES AND FUEL SUPPLY HOSE MANUFACTURED USING THE SAME

(71) Applicant: Lee Bum JEON, Daejeon (KR)

(72) Inventor: Lee Bum JEON, Daejeon (KR)

(21) Appl. No.: 15/504,645

(22) PCT Filed: Nov. 2, 2016
(86) PCT No.: PCT/KR2016/012536

§ 371 Date: Feb. 16, 2017

(30) Foreign Application Priority Data
Nov. 3, 2015 (KR) 10-2015-0154145

(51) Int. Cl. B21K 1/16; B21J 5/02; F16L 33/22; F16L 9/19; F16L 39/02; B21J 5/12; F16L 41/02

(52) U.S. Cl. CPC B21K 1/16; B21J 5/12; B21J 5/02; F16L 41/023; F16L 9/19; F16L 39/02; F16L 33/226; B23K 7/10

(57) ABSTRACT

The present invention relates to a method of manufacturing a bifurcated pipe and a bifurcated connector for connecting hoses and a fuel supply hose manufactured using the same, in which connection between a torch and an oxygen tank or a gas tank is facilitated and hoses are prevented from becoming twisted or entangled during a welding or cutting process.

Further, according to the present invention, a single connection hose is prevented from being damaged by sparks, a piece of steel cut off the workpiece, a discarded welding rod, or a sharp cut surface or edge of the workpiece, and a worker is capable of easily recognizing gas leakage and a portion from which gas is leaking, thereby preventing an accident.

### TECHNICAL FIELD

The present invention relates to a method of manufacturing a bifurcated pipe and a bifurcated connector for connecting hoses and a fuel supply hose manufactured using the same, and more particularly to a method of manufacturing a bifurcated pipe and a bifurcated connector for connecting hoses and a fuel supply hose manufactured using the same, in which connection between a torch and an oxygen tank or a gas tank is facilitated and hoses are prevented from becoming twisted or entangled during a welding or cutting process.

### BACKGROUND ART

In general, an oxygen cutting machine is a machine that is used to fuse and weld workpieces using heat, which is generated when fuel gas, such as hydrogen, acetylene, or liquefied petroleum gas (LPG), is combusted, or to cut a workpiece by spraying oxygen at a high pressure to a fused portion of the workpiece, and includes a torch, which is connected to one end of a fuel supply hose and one end of an oxygen supply hose so as to receive fuel gas and oxygen, the opposite end of the fuel supply hose and the opposite end of the oxygen supply hose being connected to a fuel gas tank and an oxygen tank, respectively.

However, a conventional oxygen cutting machine, as illustrated in FIG. 1, is typically constructed such that a gas hose 41 for supplying fuel gas is connected to a fuel gas tank 1, an oxygen hose 42 for supplying oxygen is connected to an oxygen tank 2, and both the gas hose 41 and the oxygen hose 42 are connected to a torch 3.

In the case in which the gas hose 41 and the oxygen hose 42 are used while being separately extended a long distance, the gas hose 41 and the oxygen hose 42 may become entangled while an oxygen cutting process and a welding process are being performed, which causes considerable inconvenience in performing the oxygen cutting process and in arranging the gas hose 41 and the oxygen hose 42 when the cutting process is completed.

Most of all, there have been explosions and resultant damage affecting precious human lives and property, which are caused by gas leakage due to damage of the gas hose 41 and the oxygen hose 42, which is attributable to welding sparks, a piece of steel cut off the workpiece, a discarded welding rod, or a sharp cut surface or edge of the workpiece.

In order to solve this problem, the present applicant has proposed a fuel supply hose, which is disclosed in Utility Model Registration No. 20-0293242, and which has a double-pipe and single-line structure in which a fuel gas hose is inserted into an oxygen hose and a coil spring is placed on the outer periphery of the fuel supply hose in order to prevent damage to the hose.

Alternatively, as shown in FIGS. 2 and 3, which illustrate Patent Registration No. 10-0865154, filed by another applicant, a fuel supply hose having a single-line structure, in which a gas tube 31 and an oxygen tube 32 are inserted into a single connection hose 30, which is embodied as a flexible metal pipe 30a covered with a coating 30b, is being used.

However, the above-described conventional devices are constructed such that a bifurcated connector 10 for connecting the single connection hose 30 to the fuel gas tank 1 and the oxygen tank 2 and for connecting the single connection hose 30 to the torch 3 includes a cylindrical-shaped copper pipe 11 and a branch pipe 12.

That is, the cylindrical-shaped copper pipe 11, which has a predetermined length, has a single-connection-hose connection portion 11a formed at one end thereof, to which the single connection hose 30 is connected, and a nut 21 welded to the opposite end thereof, to which the fuel gas hose 41 is connected.

In addition, the cylindrical-shaped copper pipe 11 has a hole 11a formed in the side surface thereof, and the branch pipe 12, which is formed separately from the cylindrical-shaped copper pipe 11 and is embodied as a copper pipe having a relatively small diameter and a predetermined length, is welded to the hole 11b at one end of the branch pipe 12 and is bent so that a nut 22 is welded to the opposite end of the branch pipe 12 to achieve connection with the oxygen hose 42.

In order to manufacture the bifurcated connector 10 in the prior art, a manufacturer must perform a variety of processes of purchasing copper pipes having different diameters from each other, welding two nuts 21 and 22 to the respective copper pipes, forming the hole 11b for connection with the branch pipe 12, inserting one end of the branch pipe 12 into the hole and welding the same, and bending the branch pipe 12 welded to the hole.

Therefore, the manufacturing process of the bifurcated connector 10 is labor-intensive and time-consuming, and, in particular, it is very difficult to weld the branch pipe 12 because it has a relatively small diameter, which may cause a serious problem in which the hole 11b in the branch pipe 12 becomes blocked or the branch pipe 12 is perforated to an extent that makes it impossible to use the branch pipe 12 as the bifurcated connector 10.

Further, since the branch pipe 12 has a small diameter and is made of a copper material, it may be easily bent and damaged by external force.

Furthermore, while it is easy to insert the gas tube 31 into the cylindrical-shaped copper pipe, it is very difficult to insert the oxygen tube 32 into the branch pipe 12, which is branched sideways from the cylindrical-shaped copper pipe.

In addition, since the conventional bifurcated connector 10 has no means for enabling a worker to recognize the leakage of fuel gas or oxygen, it is impossible for a worker to work without the fear of an accident.

### DISCLOSURE

### Technical Problem

The present invention has been made to solve the above problems with the prior art, and it is an object of the present invention to provide a method of manufacturing a bifurcated pipe and a bifurcated connector for connecting hoses and a fuel supply hose manufactured using the same, in which connection between a torch and an oxygen tank or a gas tank is facilitated and hoses are prevented from becoming twisted or entangled during a welding or cutting process.

It is another object of the present invention to provide a method of manufacturing a bifurcated pipe and a bifurcated connector for connecting hoses and a fuel supply hose manufactured using the same, in which a single connection hose is prevented from being damaged by sparks, a piece of steel cut off the workpiece, a discarded welding rod, or a sharp cut surface or edge of the workpiece.

It is a further object of the present invention to provide a method of manufacturing a bifurcated pipe and a bifurcated connector for connecting hoses and a fuel supply hose manufactured using the same such that a worker is capable of easily recognizing gas leakage and a portion from which gas is leaking at all times, i.e., before use, during use, or after use, and is also capable of immediately repairing the portion from which gas is leaking and of easily performing maintenance and repair, thereby preventing an accident and enabling a worker to safely perform a welding or cutting process.

### Technical Solution

In accordance with an aspect of the present invention, the above and other objects can be accomplished by the provision of a method of manufacturing a bifurcated pipe for connecting hoses, including preparing a cylindrical-shaped copper pipe by cutting a copper pipe to a predetermined length, manufacturing a bifurcated pipe such that the cylindrical-shaped copper pipe is placed into a mold and is heated so as to be easily extended and contracted, a pin for forming a single-connection-hose connection portion is inserted into one end portion of the cylindrical-shaped copper pipe, a pin for forming a gas-hose connection portion and a pin for forming an oxygen-hose connection portion are inserted into an opposite end portion of the cylindrical-shaped copper pipe, and two opposite peripheral portions of the cylindrical-shaped copper pipe corresponding to regions between the pin for forming a gas-hose connection portion and the pin for forming an oxygen-hose connection portion are pressed using pressing pins such that a single-connection-hose connection portion is formed at the one end portion of the cylindrical-shaped copper pipe and a gas-hose connection portion and an oxygen-hose connection portion are formed parallel to each other at the opposite end portion of the cylindrical-shaped copper pipe, and removing the bifurcated pipe from the mold and removing the pin for forming the single-connection-hose connection portion, the pin for forming the gas-hose connection portion and the pin for forming the oxygen-hose connection portion from the cylindrical-shaped copper pipe.

In accordance with another aspect of the present invention, a method of manufacturing a bifurcated connector for connecting hoses includes expanding an inlet hole in a single-connection-hose connection portion formed at one end portion of the bifurcated pipe manufactured according to the above-described bifurcated pipe manufacturing method so that a single connection hose is easily inserted thereinto and integrally coupling nuts, having tube outlet holes and female threaded portions formed therein, to a gas-hose connection portion and an oxygen-hose connection portion formed at an opposite end portion of the bifurcated pipe, and manufacturing nipples such that male threaded portions configured to be screw-engaged with the female threaded portions of the nuts are formed at one end portions of the nipples, hose-coupling portions are formed at opposite end portions of the nipples, and tube insertion portions having inclined tube-expanding portions are formed in front of the male threaded portions.

The method may further include forming a gas leakage hole in a body of the bifurcated connector, and a sound generator may be mounted in the gas leakage hole in order to generate a warning sound when gas leaks.

In accordance with a further aspect of the present invention, a fuel supply hose is constructed such that two opposite ends of a single connection hose having a predetermined length are coupled to respective single-connection-hose connection portions formed at respective end portions of two bifurcated connectors manufactured according to the above-described bifurcated connector manufacturing method, expanded inlets in the single-connection-hose connection portions being pressed in order to prevent the single connection hose from being separated from the single-connection-hose connection portions, distal ends of a gas tube and an oxygen tube coupled to the single connection hose are inserted through tube outlet holes in nuts coupled integrally to a gas-hose connection portion and an oxygen-hose connection portion formed at an opposite end portion of the bifurcated connector, and male threaded portions of nipples are screw-engaged with female threaded portions of the nuts, the nipples having hose-coupling portions connected with a gas hose and an oxygen hose, tube insertion portions formed in front of the male threaded portions being inserted into the gas tube and the oxygen tube, and the distal ends of the gas tube and the oxygen tube being expanded by inclined tube-expanding portions and being brought into close contact with and secured to inner surfaces of the nuts so as not to be separated therefrom.

### Advantageous Effects

A method of manufacturing a bifurcated pipe and a bifurcated connector for connecting hoses and a fuel supply hose manufactured using the same according to the present invention have an advantage in that a copper pipe having a single diameter is used by cutting the same to a predetermined length, thereby making it possible to manufacture the bifurcated pipe much more quickly and conveniently than in the conventional bifurcated pipe manufacturing method, in which a variety of labor-intensive processes, including cutting two copper pipes having different diameters from each other and bending the cut copper pipe having a relatively small diameter to a predetermined angle and welding the same, must be performed.

Further, according to the present invention, there is an advantage in that, since a gas-hose connection portion and an oxygen-hose connection portion are connected such that a pressed portion is formed therebetween, the bifurcated pipe has a strong structure and it is easy to insert a gas hose and an oxygen hose into the bifurcated pipe through the gas-hose connection portion and the oxygen-hose connection portion, respectively.

Further, according to the present invention, the bifurcated connector is simply manufactured using the bifurcated pipe, which is manufactured much more quickly and conveniently than in the conventional bifurcated pipe manufacturing method, such that rear end portions of nuts, to which nipples are connected, are welded to the gas-hose connection portion and the oxygen-hose connection portion, respectively, which extend separately from each other, thereby making it possible to manufacture the bifurcated connector much more quickly and conveniently than in the conventional bifurcated connector manufacturing method.

Furthermore, according to the present invention, a gas leakage hole is formed in a body of the bifurcated connector in order to allow gas to leak through the gas leakage hole, and a sound generator is mounted in the gas leakage hole in order to generate a warning sound when gas leaks, thereby enabling a worker to easily recognize gas leakage during use or after use and to easily perform maintenance and repair, thereby preventing an accident.

In addition, according to the present invention, connection with the bifurcated connector is easy, twisting or entanglement of a hose does not occur, and a single connection hose is prevented from being damaged by sparks, a piece of steel cut off the workpiece, a discarded welding rod, or a sharp cut surface or edge of the workpiece.

### DESCRIPTION OF DRAWINGS

FIGS. 1 to 3 are views illustrating the hose connection state of a conventional oxygen cutting machine, in which:

FIG. 1 is a view illustrating the hose connection state in which a fuel gas hose and an oxygen hose are separately extended,

FIG. 2 is a view illustrating the hose connection state using a single connection hose, and

FIG. 3 is a view illustrating the construction of a conventional bifurcated connector for connecting hoses,

FIGS. 4 to 6 are views illustrating the processes of manufacturing a bifurcated pipe for connecting hoses according to the present invention, in which:

FIG. 4 is a perspective view illustrating a cylindrical-shaped copper pipe formed by cutting a copper pipe to a predetermined length,

FIG. 5 is a view illustrating the state in which the cylindrical-shaped copper pipe is placed into a mold and pins for forming respective connection portions are coupled to the cylindrical-shaped copper pipe, and

FIG. 6 is a view illustrating the state in which the bifurcated pipe is manufactured by pressing a distal end portion of the copper pipe using pressing pins,

FIG. 7 is an exploded perspective view illustrating the construction of a bifurcated connector according to the present invention,

FIGS. 8 to 10 are views illustrating a fuel supply hose using the bifurcated connector according to the present invention, in which:

FIG. 8 is a perspective view illustrating the fuel supply hose according to the present invention,

FIG. 9 is a sectional view illustrating the state before the fuel supply hose according to the present invention is assembled, and

FIG. 10 is a sectional view illustrating the fuel supply hose according to the present invention, and

FIG. 11 is a view illustrating the state in which hoses of an oxygen cutting machine are connected using the fuel supply hose according to the present invention.

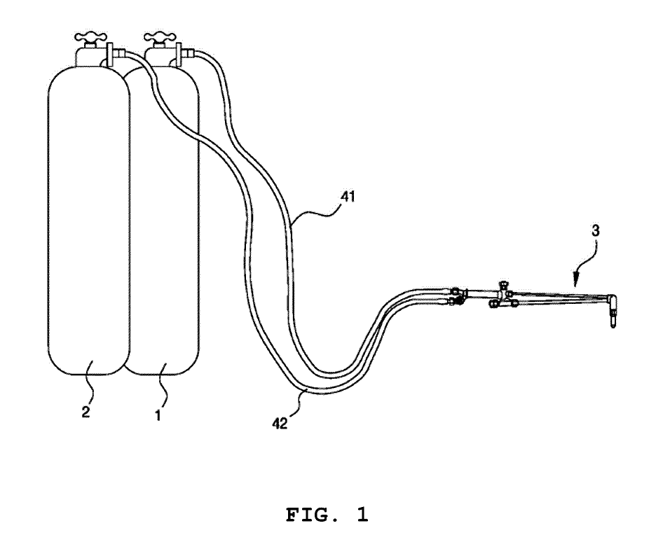

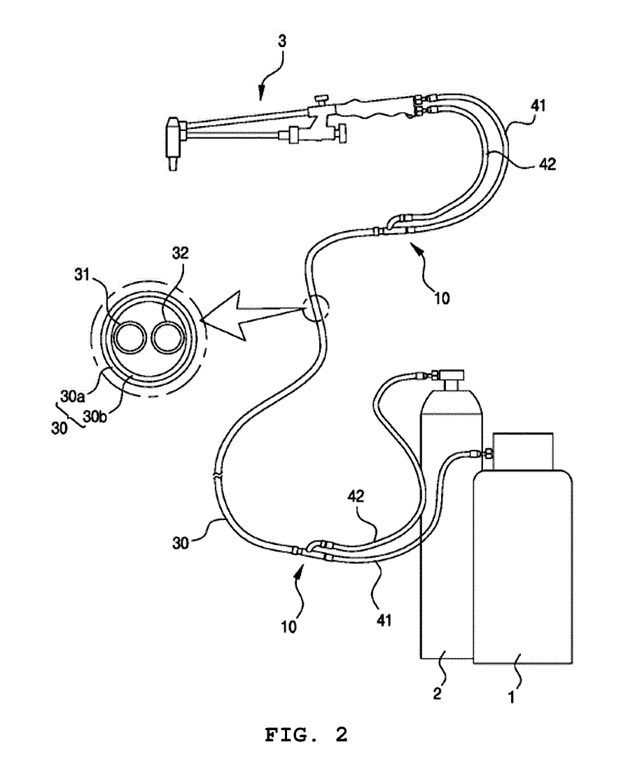

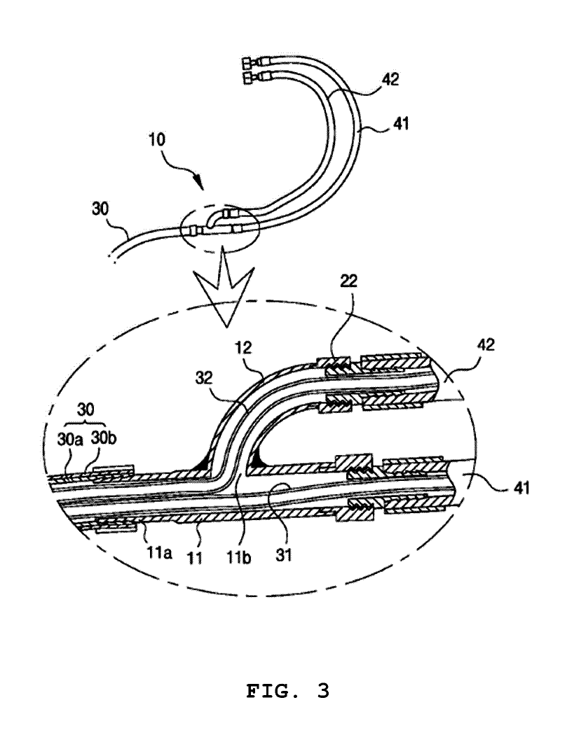

### BEST MODE

Hereinafter, advantages and features of the present invention and methods for achieving them will be made clear from the embodiments described below in detail with reference to the accompanying drawings. The preferred embodiments described in the specification and shown in the drawings are illustrative only and are not intended to represent all aspects of the invention, such that various equivalents and modifications can be made. In the following description, a detailed description of known functions and configurations incorporated herein will be omitted when it may make the subject matter of the present invention rather unclear. In the drawings, dimensions of constituent elements do not entirely reflect actual dimensions and may be exaggerated for description convenience and clarity.

The present invention relates to a method of manufacturing a bifurcated pipe and a bifurcated connector for connecting hoses and a fuel supply hose manufactured using the same

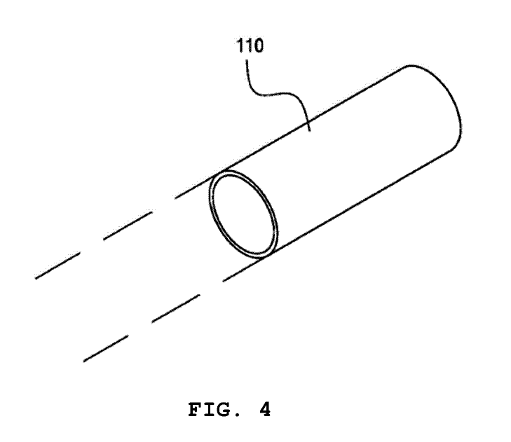

First, a method of manufacturing a bifurcated pipe for connecting hoses will be described with reference to FIGS. 4 to 6.

The first step of the method of manufacturing the bifurcated pipe for connecting hoses according to the present invention, as shown in FIG. 4, is to prepare a cylindrical-shaped copper pipe 110 by cutting a copper pipe to a predetermined length.

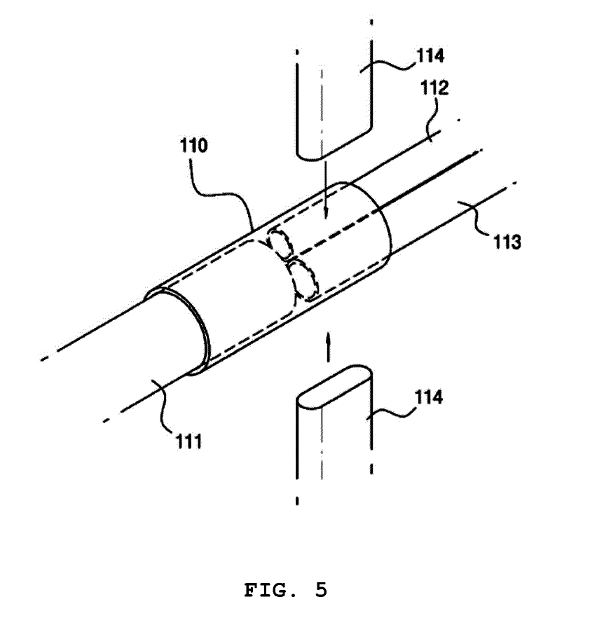

Subsequently, the cylindrical-shaped copper pipe 110 is placed into a mold (not illustrated). At this time, it is preferable for the cylindrical-shaped copper pipe 110 to be heated so as to be easily extended and contracted. As shown in FIG. 5, a pin 111 for forming a single-connection-hose connection portion is inserted into one end portion of the cylindrical-shaped copper pipe 110, a pin 112 for forming a gas-hose connection portion and a pin 113 for forming an oxygen-hose connection portion are inserted into the opposite end portion of the cylindrical-shaped copper pipe 110, and two opposite peripheral portions of the cylindrical-shaped copper pipe 110, which correspond to regions between the pin 112 for forming the gas-hose connection portion and the pin 113 for forming the oxygen-hose connection portion, are pressed using pressing pins 114. Through these processes, a bifurcated pipe 100 is manufactured such that a single-connection-hose connection portion 101 is formed at one end portion of the cylindrical-shaped copper pipe 110 and a gas-hose connection portion 102 and an oxygen-hose connection portion 103 are formed parallel to each other at the opposite end portion of the cylindrical-shaped copper pipe 110.

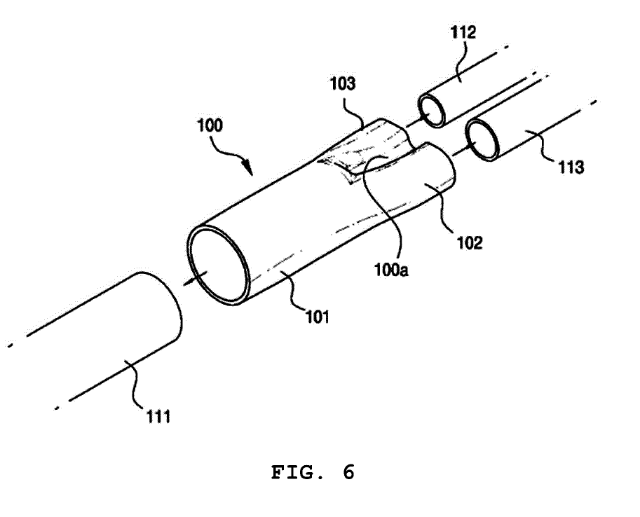

Subsequently, the bifurcated pipe 100 is removed from the mold, and, as shown in FIG. 6, the pin 111 for forming the single-connection-hose connection portion, the pin 112 for forming the gas-hose connection portion and the pin 113 for forming the oxygen-hose connection portion are removed from the cylindrical-shaped copper pipe 110.

The component used in the method of manufacturing the bifurcated pipe according to the present invention is not limited to the cylindrical-shaped copper pipe 110, which is embodied as a copper pipe, and pipes of various other metal materials may also be used.

According to the above-described method of manufacturing the bifurcated pipe for connecting hoses according to the present invention, a copper pipe having a single diameter is used by cutting the same to a predetermined length. Accordingly, it is possible to manufacture the bifurcated pipe 100 much more quickly and conveniently in the manufacturing method according to the present invention than in the conventional bifurcated pipe manufacturing method, in which a variety of labor-intensive processes, including cutting two copper pipes having different diameters from each other to a predetermined length and bending the cut copper pipe having a relatively small diameter to a predetermined angle and welding the same, must be performed.

Further, since the gas-hose connection portion 102 and the oxygen-hose connection portion 103 are connected such that a pressed portion 100a is formed therebetween, the bifurcated pipe has a strong structure, and it is easy to insert a gas hose 210 and an oxygen hose 220 into the bifurcated pipe through the gas-hose connection portion 102 and the oxygen-hose connection portion 103, respectively.

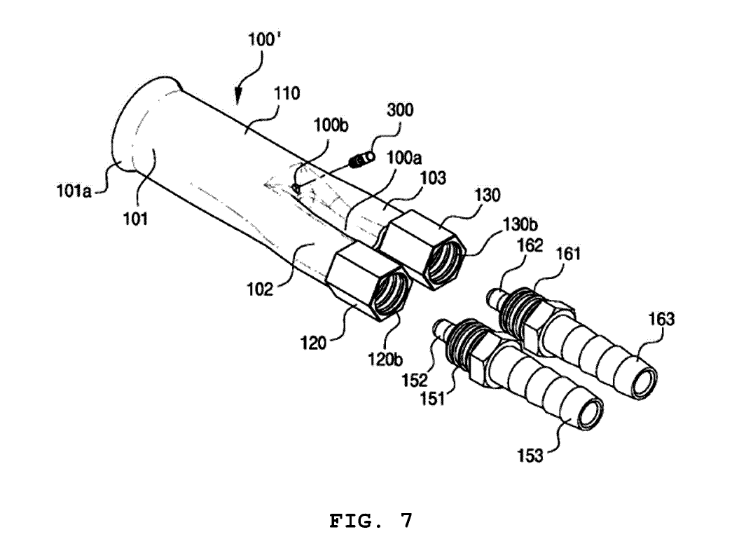

Now, a method of manufacturing a bifurcated connector 100′ using the bifurcated pipe, which is manufactured according to the above-described method of manufacturing the bifurcated pipe for connecting hoses, will be described with reference to FIG. 7.

First, an inlet hole 101a in the single-connection-hose connection portion 101, which is formed at one end portion of the bifurcated pipe 100 manufactured according to the above-described method, is expanded so that a single connection hose 200 is easily inserted thereinto, and the gas-hose connection portion 102 and the oxygen-hose connection portion 103, which are formed at the opposite end portion of the bifurcated pipe 100, are inserted into and welded to rear end portions of nuts 120 and 130, respectively, which have tube outlet holes 120a and 130a and female threaded portions 120b and 130b.

Next, nipples 150 and 160 are manufactured such that male threaded portions 151 and 161, which are configured to be screw-engaged with the female threaded portions 120b and 130b of the nuts 120 and 130, are formed at one end portions of the nipples 150 and 160, hose-coupling portions 153 and 163 are formed at the opposite end portions of the nipples 150 and 160, and tube insertion portions 152 and 162, which have inclined tube-expanding portions 152a and 162a, are formed in front of the male threaded portions 151 and 161.

Since the rear end portions of the nuts 120 and 130, to which the nipples are connected, are welded to the gas-hose connection portion 102 and the oxygen-hose connection portion 103, respectively, which extend separately from each other, it is possible to manufacture the bifurcated connector 100′ more quickly and conveniently in the bifurcated connector manufacturing method according to the present invention than in the conventional bifurcated connector manufacturing method.

In addition, a gas leakage hole 100b may be formed in the body of the bifurcated connector 100′. When the connection portion of the gas tube 201 or the oxygen tube 202, which is mounted in the bifurcated connector 100′, is damaged or loosened, gas leaks through the gas leakage hole 100b. Therefore, when gas leakage occurs, a worker is able to recognize the gas leakage through the gas leakage hole 100b, thereby enabling a worker to check for gas leakage at all times and consequently facilitating maintenance and repair and preventing an accident.

Furthermore, in the present invention, a sound generator 300 may be mounted in the gas leakage hole 100b in order to generate a warning sound when gas leaks.

Since this enables a worker to immediately recognize gas leakage from the sound, it is not necessary for a worker to check for gas leakage frequently, thereby providing convenience for a worker.

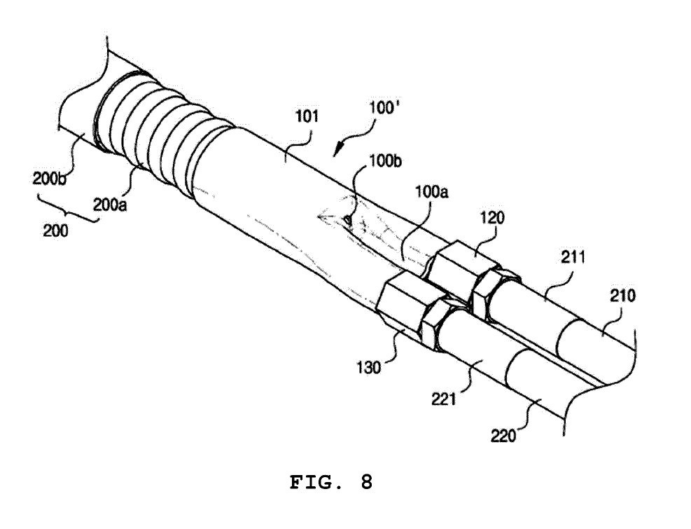

Now, a fuel supply hose of an oxygen cutting machine, which is manufactured using the bifurcated connector manufactured according to the above-described method of the present invention, will be described with reference to FIGS. 8 to 11.

In order to manufacture the fuel supply hose depicted in FIG. 11, two opposite ends of the single connection hose 200 having a predetermined length are coupled to the respective single-connection-hose connection portions 101, which are formed at respective end portions of the two bifurcated connectors 100′, which are manufactured according to the above-described bifurcated connector manufacturing method of the present invention. As shown in FIG. 8, the expanded inlet 101a in each single-connection-hose connection portion 101 is pressed in order to prevent the single connection hose 200 from being separated from the single-connection-hose connection portion 101.

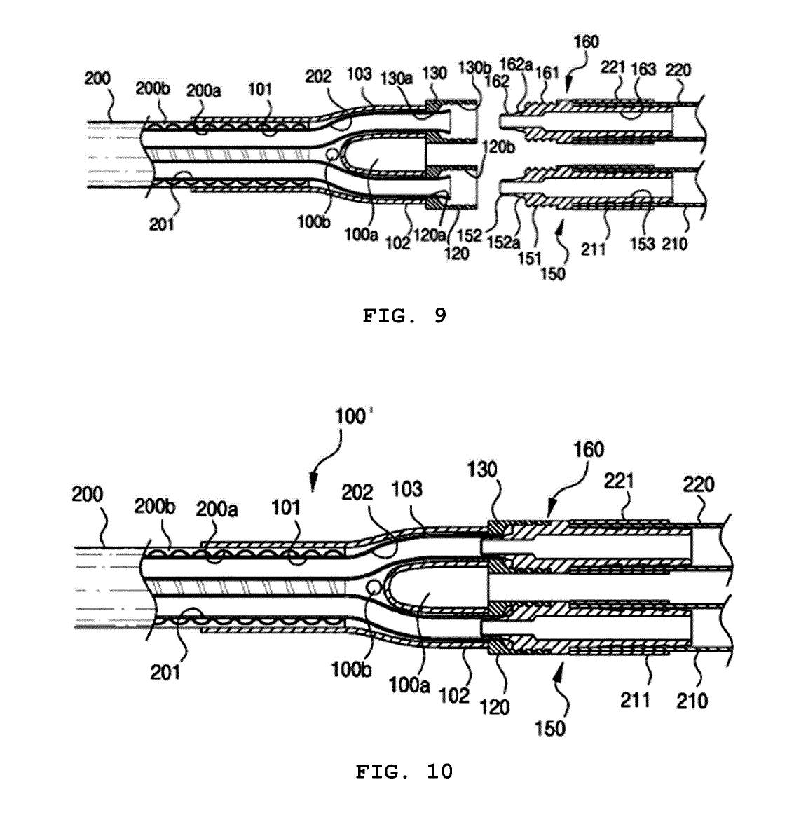

Before this process of connecting the single connection hose 200, as shown in FIG. 9, the distal ends of the gas tube 201 and the oxygen tube 202, which are coupled to the single connection hose 200, are respectively inserted through the tube outlet hole 120a in the nut 120, which is integrally welded to the gas-hose connection portion 102 formed at the opposite end portion of the bifurcated connector 100′, and through the tube outlet hole 130a in the nut 130, which is integrally welded to the oxygen-hose connection portion 103 formed at the opposite end portion of the bifurcated connector 100′.

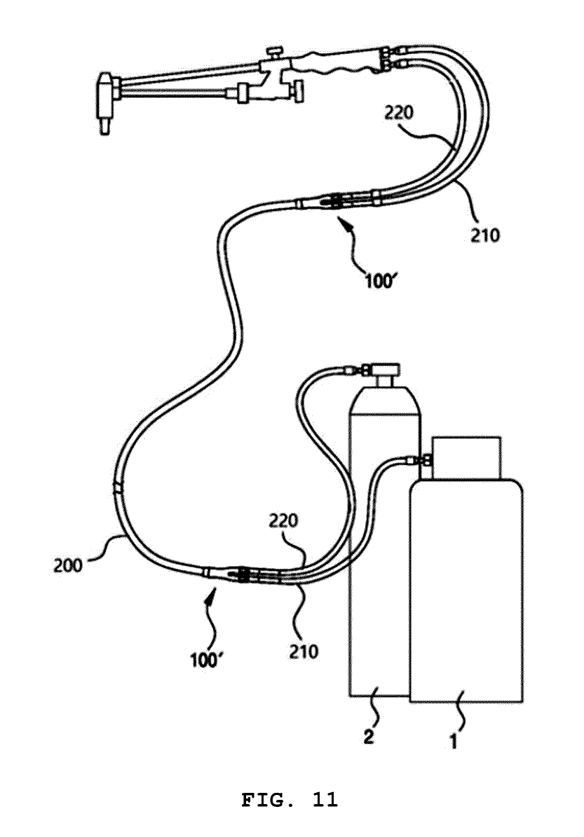

Next, as shown in FIG. 10, the male threaded portions 151 and 161 of the nipples 150 and 160, the hose-coupling portions 153 and 163 of which are connected with the gas hose 210 and the oxygen hose 220, are screw-engaged with the female threaded portions 120b and 130b of the nuts 120 and 130.

The tube insertion portions 152 and 162, which are formed in front of the male threaded portions 151 and 161, are inserted into the gas tube 201 and the oxygen tube 202, and the distal ends of the gas tube 201 and the oxygen tube 202 are expanded by the inclined tube-expanding portions 152a and 162a and are brought into close contact with the inner surfaces of the nuts 120 and 130.

The single connection hose 200 may be manufactured in various structures and may be embodied as a flexible hose, which is made of a material that is freely bent and is characterized by toughness. For instance, a flexible metal pipe 200a covered with a coating 200b on the outer surface thereof or a flexible hose covered with a metal mesh on the inner surface thereof may be used as the single connection hose 200.

As shown in FIG. 8, caps 211 and 221 may be mounted to the distal ends of the gas hose 210 and the oxygen hose 220 in order to securely support the nipples 150 and 160, which are inserted into the gas hose 210 and the oxygen hose 220.

As described above, the fuel supply hose of the present invention is characterized in that the manufacturing process thereof is simple and in that it has a single-line structure such that the gas tube 201 and the oxygen tube 202 are inserted into the single connection hose 200, thereby preventing the hose from becoming twisted or entangled.

Further, when the fuel supply hose according to the present invention is used, there is no risk of the single connection hose 200 being damaged by sparks, a piece of steel cut off the workpiece, a discarded welding rod, or a sharp cut surface or edge of the workpiece.

Furthermore, when the fuel supply hose according to the present invention is used, a worker is able to recognize gas leakage, which may occur when the connection portion of the gas tube 201 or the oxygen tube 202 mounted in the bifurcated connector 100′ is damaged or loosened, from the smell or sound escaping through the gas leakage hole 100b. As a result, because a worker may recognize gas leakage immediately when it occurs, it is easy to perform maintenance and repair, and it is possible to prevent an accident.

While the present invention has been described in connection with only a limited number of exemplary embodiments and drawings, the present invention is not limited thereto, and it should be understood that various modifications and changes may be made by those skilled in the art within the spirit of the invention and the appended claims and their equivalents.

What is claimed is:

1. A method of manufacturing a bifurcated pipe for connecting hoses, comprising:
preparing a cylindrical-shaped copper pipe by cutting a copper pipe to a predetermined length;
manufacturing a bifurcated pipe such that the cylindrical-shaped copper pipe is placed into a mold and is heated so as to be easily extended and contracted, a pin for forming a single-connection-hose connection portion is inserted into one end portion of the cylindrical-shaped copper pipe, a pin for forming a gas-hose connection portion and a pin for forming an oxygen-hose connection portion are inserted into an opposite end portion of the cylindrical-shaped copper pipe, and two opposite peripheral portions of the cylindrical-shaped copper pipe corresponding to regions between the pin for forming a gas-hose connection portion and the pin for forming an oxygen-hose connection portion are pressed using pressing pins such that a single-connection-hose connection portion is formed at the one end portion of the cylindrical-shaped copper pipe and a gas-hose connection portion and an oxygen-hose connection portion are formed parallel to each other at the opposite end portion of the cylindrical-shaped copper pipe; and
removing the bifurcated pipe from the mold and removing the pin for forming the single-connection-hose connection portion, the pin for forming the gas-hose connection portion and the pin for forming the oxygen-hose connection portion from the cylindrical-shaped copper pipe.

2. A method of manufacturing a bifurcated connector for connecting hoses, comprising:
expanding an inlet hole in a single-connection-hose connection portion formed at one end portion of the bifurcated pipe manufactured according to the method of claim 1 so that a single connection hose is easily inserted thereinto and integrally coupling nuts, having tube outlet holes and female threaded portions formed therein, to a gas-hose connection portion and an oxygen-hose connection portion formed at an opposite end portion of the bifurcated pipe; and
manufacturing nipples such that male threaded portions configured to be screw-engaged with the female threaded portions of the nuts are formed at one end portions of the nipples, hose-coupling portions are formed at opposite end portions of the nipples, and tube insertion portions having inclined tube-expanding portions are formed in front of the male threaded portions.

3. The method according to claim 2, further comprising:
forming a gas leakage hole in a body of the bifurcated connector.

4. The method according to claim 3, wherein a sound generator is mounted in the gas leakage hole in order to generate a warning sound when gas leaks.

5. A fuel supply hose, wherein two opposite ends of a single connection hose having a predetermined length are coupled to respective single-connection-hose connection portions formed at respective end portions of two bifurcated connectors manufactured according to the method of claim 2, expanded inlets in the single-connection-hose connection portions being pressed in order to prevent the single connection hose from being separated from the single-connection-hose connection portions,
distal ends of a gas tube and an oxygen tube coupled to the single connection hose are inserted through tube outlet holes in nuts coupled integrally to a gas-hose connection portion and an oxygen-hose connection portion formed at an opposite end portion of the bifurcated connector, and
male threaded portions of nipples are screw-engaged with female threaded portions of the nuts, the nipples having hose-coupling portions connected with a gas hose and an oxygen hose, tube insertion portions formed in front of the male threaded portions being inserted into the gas tube and the oxygen tube, and the distal ends of the gas tube and the oxygen tube being expanded by inclined tube-expanding portions and being brought into close contact with and secured to inner surfaces of the nuts so as not to be separated therefrom.
